(19) United States
(12) Patent Application Publication
(10) Pub. No.: US 2014/0285081 A1
(43) Pub. Date: Sep. 25, 2014

(54) VENDING MACHINE

(71) Applicants: Hon Hai Precision Industry Co., Ltd., New Taipei (TW); Hong Fu Jin Precision Industry (WuHan) Co., Ltd., Wuhan (CN)

(72) Inventors: SHUAI WU, Wuhan (CN); SHU-QI WU, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/132,485

(22) Filed: Dec. 18, 2013

(30) Foreign Application Priority Data
Mar. 25, 2013 (CN) 2013100962168

(51) Int. Cl. G07F 9/10

(52) U.S. Cl. CPC G07F 9/10
USPC 312/334.1

(57) ABSTRACT

A vending machine includes a casing with an opening, a door assembly slidably attached to the casing, and a door opening/closing assembly. The door opening/closing assembly includes a mounting bracket attached to an inner wall of the casing, a gear rod slidably attached to the mounting bracket, and a driving device engaging with the gear rod. One end of the gear rod is secured to the door assembly. The driving device is capable of sliding the gear rod along the mounting bracket between a closed position, where the door assembly shields the opening, and an open position, where the door assembly is disengaged away from the opening for exposing the opening.

### BACKGROUND

1. Technical Field

The present disclosure relates to a vending machine, and more particularly to a vending machine with a door opening/closing assembly.

2. Description of Related Art

A vending machine includes a casing and a door assembly pivotably attached to the casing. A lot of devices or products are attached to an inner side of the door assembly. The door assembly is heavy, and it's difficult for a user to open or close the door assembly.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of an embodiment of a vending machine.

FIG. 2 is an exploded view of a door opening/closing assembly of FIG. 1.

FIG. 3 is an assembled view of the door opening/closing assembly of FIG. 2.

FIG. 4 is an assembled view of the vending machine of FIG. 1.

### DETAILED DESCRIPTION

The disclosure is illustrated by way of example and not by way of limitation.

In the figures of the accompanying drawings in which like references indicate similar elements. It should be noted that references to “an” or “one” embodiment in this disclosure are not necessarily to the same embodiment, and such references mean “at least one.”

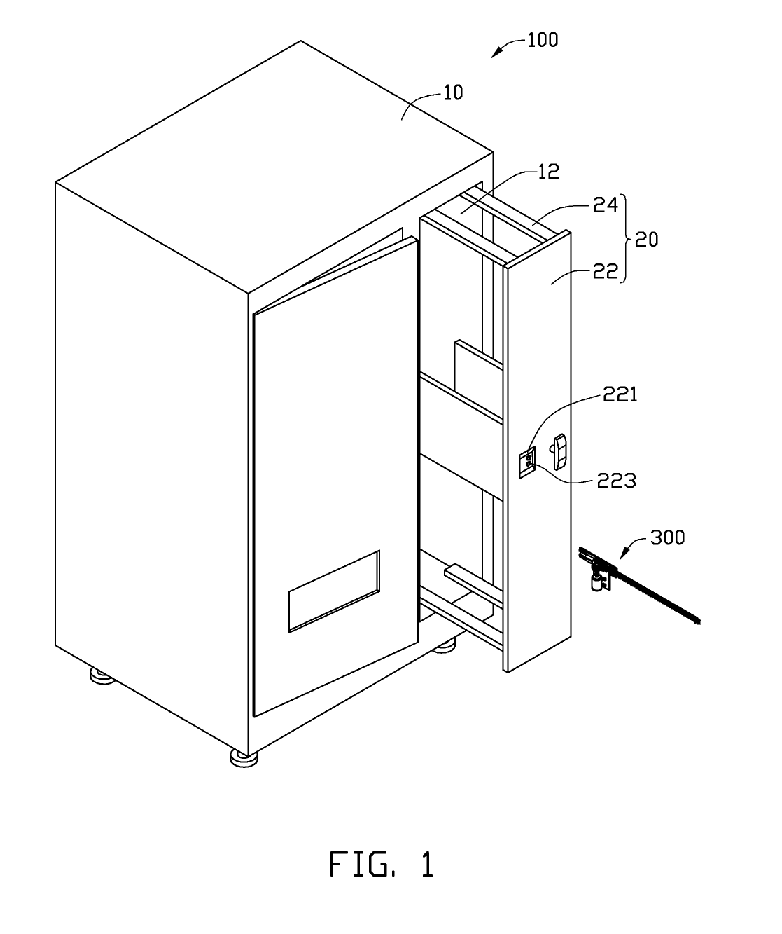

FIG. 1 shows an embodiment of a vending machine includes a chassis 100 and a door opening/closing assembly 300. The chassis 100 includes a casing 10 and a door assembly 20 slidably attached to the casing 10. The door assembly 20 includes a door panel 22 and two pairs of mounting strips 24 extending substantially perpendicularly from the door panel 22. The two pairs of mounting strips 24 are located adjacent to two short edges of the door panel 22 and abut against a top wall and a lower wall of the casing 10. An opening 12 is defined at a front wall of the casing 10. A shape and size of the opening 12 is substantially the same as the shape and size of the door panel 22. When the door assembly 20 is slid to a closed position, the opening 12 is shielded by the door panel 22. When the door assembly 20 is slid to an open position, the opening 12 is exposed. A door close button 221 and a door open button 223 are mounted at the door panel 22.

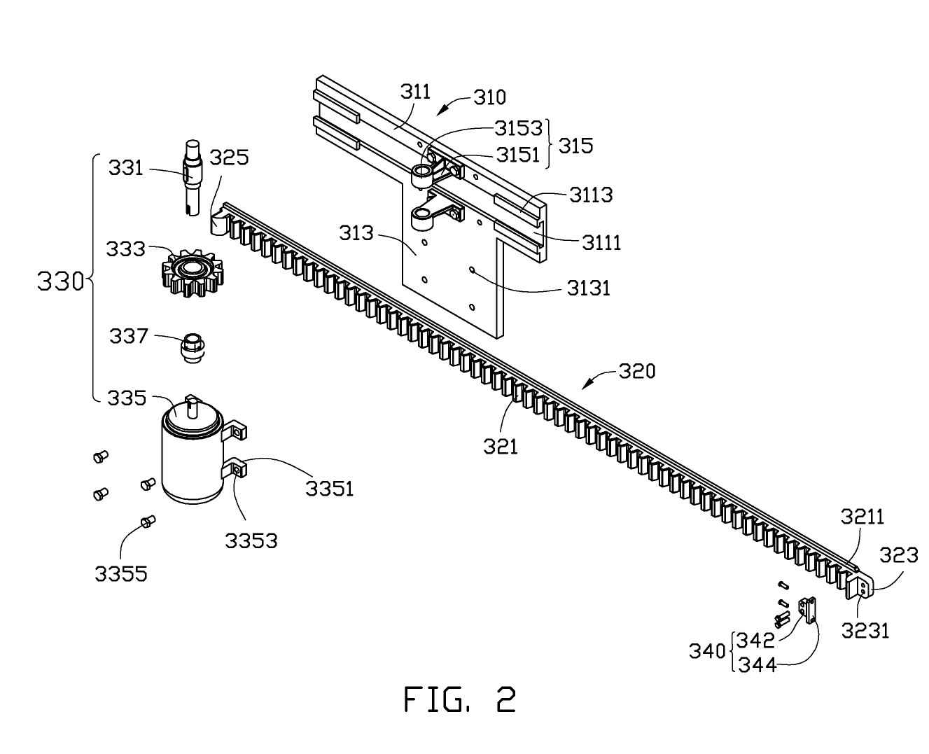

FIG. 2 shows the door opening/closing assembly 300 includes a mounting bracket 310, a gear rod 320, a driving device 330, and a connecting member 340. The mounting bracket 310 has a T-shape and includes a holding plate 311 and a securing plate 313 connected to the holding plate 311. A sliding slot 3111 is defined at the holding plate 311 for slidably mounting the gear rod 320. Two pairs of clamping blocks 3113 are located beside the sliding slot 3111 for preventing the gear rod 320 from disengaging from the sliding slot 3111 along a direction perpendicular to the holding plate 311. A pair of mounting members 315 is attached to the mounting bracket 310 and located at opposite sides of the sliding slot 3111. Each of the mounting members 315 includes a leg 3151 substantially perpendicularly attached to the mounting bracket 310 and a ring-shaped cylinder 3153 located at a distal end of the leg 3151. A plurality of securing holes 3131 is defined in the securing plate 313.

The gear rod 320 includes a long narrow main body 321, a connecting piece 323, and a blocking piece 325. A pair of sticks 3211 protrudes from upper and lower sides of the gear rod 320. The connecting piece 323 extends forward from a front end of the gear rod 320. The blocking piece 325 extends substantially perpendicularly from the long narrow main body 321 and located at a rear end of the gear rod 320. A pair of fixing holes 3231 is defined in the connecting piece 323 for securing the connecting member 340. A plurality of teeth-shaped protrusions is formed at the long narrow main body 321. The plurality of teeth-shaped protrusions is located between the connecting piece 323 and the blocking piece 325, and located between the pair of sticks 3211.

The driving device 330 includes a pivot shaft 331, a gear member 333 engageable with the gear rod 320, a motor 335, and a connecting shaft 337. The motor 335 includes a plurality of L-shaped mounting tabs 3351. A mounting hole 3353 is defined in each of the plurality of L-shaped mounting tabs 3351.

The connecting member 340 has a T shape and includes a first mounting piece 342 and a second mounting piece 344 extending substantially perpendicularly from the first mounting piece 342.

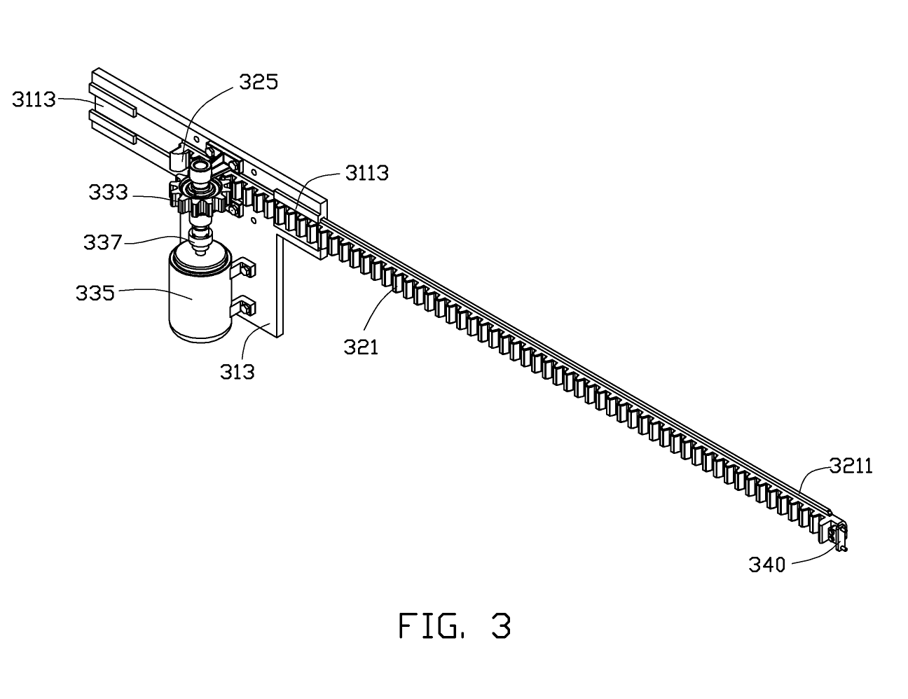

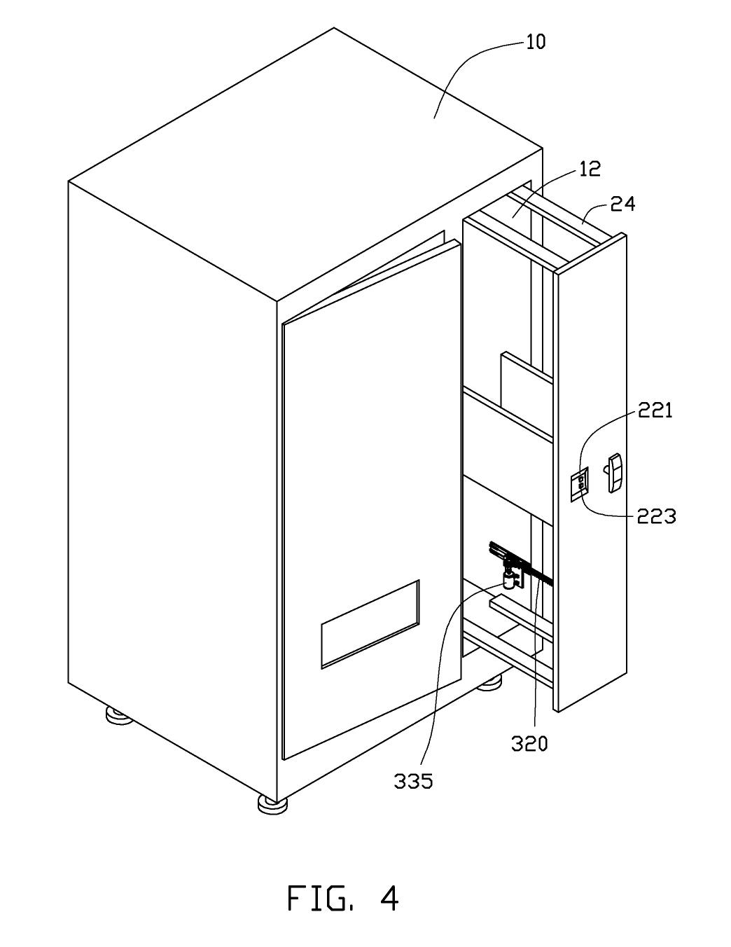

FIGS. 3 and 4 show that in assembly, the gear rod 320 is slidably mounted in the sliding slot 3111. The pair of sticks 3211 is clamped by the two pairs of clamping blocks 3113. The gear member 333 is secured to a central portion of the pivot shaft 331. Two ends of the pivot shaft 331 extend through the pair of ring-shaped cylinders 3153. The gear member 333 is located between the pair of mounting members 315. A lower end of the pivot shaft 331 protrudes from a lower one of the pair of ring-shaped cylinders 3153 and is connected to the connecting shaft 337. The connecting shaft 337 is attached to the motor 335. The lower end of the pivot shaft 331 is connected to the motor 335 and movable together with the motor 335. A plurality of fasteners 3355 extends through the mounting hole 3353 and a corresponding one of the plurality of securing holes 3131 for securing the motor 335 to the securing plate 313. The door opening/closing assembly 300 is assembled.

The mounting bracket 310 is mounted on an inner side of the casing 10. The first mounting piece 342 is securely attached to the connecting piece 323. The second mounting piece 344 is securely attached to an inner side of the door panel 22. The gear rod 320 is substantially perpendicular to the door panel 22.

When the door close button 221 is pressed and active, the vending machine sends an instruction to rotate the motor 335 counter-clockwise. The pivot shaft 331 and the gear member 333 rotate counter-clockwise correspondingly. The gear member 333 drives the gear rod 320 rearward. The gear rod 320 pulls the door assembly 20 to the closed position. The opening 12 is shielded by the door panel 22.

When the door open button 223 is pressed and activated, the vending machine sends another instruction to rotate the motor 335 clockwise. The pivot shaft 331 and the gear member 333 rotate clockwise correspondingly. The gear member 333 drives the gear rod 320 forward. The gear rod 320 pushes the door assembly 20 to the open position. The opening 12 is exposed.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A vending machine comprising:
a casing comprising an opening;
a door assembly slidably attached to the casing; and
a door opening/closing assembly comprising a mounting bracket attached to an inner wall of the casing, a gear rod slidably attached to the mounting bracket, and a driving device engaging with the gear rod; and one end of the gear rod being secured to the door assembly;
wherein the driving device is capable of driving the gear rod to slide along the mounting bracket between a closed position, where the opening is shielded by the door assembly, and an open position, where the door assembly is disengaged away from the opening for exposing the opening.

2. The vending machine of claim 1, wherein the door assembly comprises a door panel for shielding the opening and two pairs of mounting strips extending substantially perpendicularly from the door panel; the two pairs of mounting strips are located adjacent to opposite side edges of the door panel and abut against a top wall and a lower wall of the casing; and a shape and size of the opening is substantially the same as the shape and size of the door panel.

3. The vending machine of claim 2, wherein a moving direction of the gear rod is substantially perpendicular to the door panel.

4. The vending machine of claim 2, wherein the mounting bracket is T-shaped and comprises a holding plate and a securing plate connected to the holding plate, a sliding slot is defined at the holding plate for slidably mounting the gear rod; and the driving device comprises a motor secured to the securing plate to drive the gear rod to slide along the sliding slot.

5. The vending machine of claim 4, wherein the gear rod comprises a connecting piece located at one end of the gear rod, a T-shaped connecting member comprises a first mounting piece secured to the connecting piece, and a second mounting piece secured to the door panel.

6. The vending machine of claim 5, wherein the gear rod comprises two pairs of clamping blocks located beside the sliding slot for preventing the gear rod from disengaging from the sliding slot along a direction that is perpendicular to the holding plate.

7. The vending machine of claim 6, wherein a pair of sticks protrudes from upper and lower sides of the gear rod, and the pair of sticks is clamped by the two pairs of clamping blocks.

8. The vending machine of claim 7, wherein the driving device further comprises a gear member engaged with the gear rod, the motor is connected to the gear member and is capable of driving the gear member rotating along the gear rod, and the gear rod is capable of sliding along the sliding slot while the gear member is rotating along the gear rod.

9. The vending machine of claim 8, wherein the driving device further comprises a pivot shaft that is connected to the motor and rotatable together with the motor, and the gear member is secured to the pivot shaft and rotatable with the pivot shaft.

10. The vending machine of claim 9, wherein a pair of mounting members are secured to the mounting bracket and located at opposite sides of the sliding slot, two ends of the pivot shaft are pivotably attached to the pair of mounting members, and the gear member is located between the pair of mounting members.

11. A vending machine comprising:
a casing comprising an opening;
a door assembly, slidably attached to the casing, comprising a door panel and a pair of mounting strips extending substantially perpendicularly from the door panel and slidable along inner surfaces of the casing;
a mounting bracket attached to an inner wall of the casing;
a gear rod slidably attached to the mounting bracket; and
a driving device, engaging with the gear rod, and comprising one end secured to the door assembly;
wherein the driving device is capable of driving the gear rod to slide along the mounting bracket between a closed position, where the opening is shielded by the door assembly, and an open position, where the door assembly is disengaged away from the opening for exposing the opening.

12. The vending machine of claim 11, wherein a moving direction of the gear rod is substantially perpendicular to the door panel.

13. The vending machine of claim 12, wherein the mounting bracket is T-shaped and comprises a holding plate and a securing plate connected to the holding plate, a sliding slot is defined at the holding plate for slidably mounting the gear rod; and the driving device comprises a motor secured to the securing plate to drive the gear rod to slide along the sliding slot.

14. The vending machine of claim 13, further comprising a T-shaped connecting member secured to the gear rod, wherein the gear rod comprises a connecting piece located at one end of the gear rod, and the T-shaped connecting member comprises a first mounting piece secured to the connecting piece and a second mounting piece secured to the door panel.

15. The vending machine of claim 14, wherein the gear rod comprises two pairs of clamping blocks located beside the sliding slot for preventing the gear rod from disengaging from the sliding slot along a direction that is perpendicular to the holding plate.

16. The vending machine of claim 15, wherein a pair of sticks protrudes from upper and lower sides of the gear rod, and the pair of sticks is clamped by the two pairs of clamping blocks.

17. The vending machine of claim 16, wherein the driving device further comprises a gear member engaged with the gear rod, the motor is connected to the gear member and is capable of driving the gear member rotating along the gear rod, and the gear rod is capable of sliding along the sliding slot while the gear member is rotating along the gear rod.

18. The vending machine of claim 17, wherein the gear rod further comprises a pair of blocking pieces located adjacent to opposite ends of the gear rod for preventing the gear member rotating away from the gear rod.

19. The vending machine of claim 17, wherein the driving device further comprises a pivot shaft that is connected to the motor and rotatable together with the motor, and the gear member is secured to the pivot shaft and rotatable with the pivot shaft.

20. The vending machine of claim 19, wherein a pair of mounting members are secured to the mounting bracket and located at opposite sides of the sliding slot, two ends of the pivot shaft are pivotably attached to the pair of mounting members, and the gear member is located between the pair of mounting members.
